(19) United States
(12) Patent Application Publication
(10) Pub. No.: US 2023/0297063 A1
(43) Pub. Date: Sep. 21, 2023

(54) METHOD, SYSTEM, AND APPARATUS FOR FORMING A WORKPIECE

(71) Applicant: Promess, Inc., Brighton, MI (US)

(72) Inventors: Andrew H. Joseph, Milford, MI (US); Neil Suva, Brighton, MI (US); Matthew R. Rall, Howell, MI (US); Bret Tucker, Brighton, MI (US); Scot C. Stodart, Pinckney, MI (US); Glenn W. Nausley, JR., Howell, MI (US)

(73) Assignee: Promess, Inc., Brighton, MI (US)

(21) Appl. No.: 18/185,278

(22) Filed: Mar. 16, 2023

Related U.S. Application Data
(60) Provisional application No. 63/321,389, filed on Mar. 18, 2022.

(51) Int. Cl. G05B 19/402; G05B 13/02

(52) U.S. Cl. CPC G05B 19/402; G05B 13/0265; G05B 2219/35515

(57) ABSTRACT

A system for straightening a workpiece includes a fabricating machine; a dimensional measurement system; a machine learning module; and a controller. The controller determines a plurality of design dimensions for the workpiece, and determines, via the dimensional measurement system, a plurality of initial dimensional parameters for the workpiece. A plurality of settings for the fabricating machine are determined, via the machine learning module, based upon the plurality of initial dimensional parameters for the workpiece and the plurality of design dimensions for the workpiece. The workpiece is secured into the fixture, and the fabricating machine is arranged employing the plurality of settings. The fabricating machine executes a plurality of operations on the workpiece employing the plurality of settings for the fabricating machine, and the dimensional measurement system verifies that the workpiece exhibits the plurality of design dimensions.

### CROSS-REFERENCE TO RELATED APPLICATIONS

This application claims the benefit of U.S. Provisional Patent Application No. 63/321,389 filed on Mar. 18, 2022, the disclosure of which is hereby incorporated by reference.

### TECHNICAL FIELD

The concepts described herein relate to manufacturing processes and the implementation of machine learning thereto.

### INTRODUCTION

Straightening feed metal stock or semi-finished workpieces for applications like axles, shafts, posts, etc., may include bending based on pre-programmed mathematical relationships in response to a measured distortion on the workpiece.

The straightening of a metal manufactured part, especially one that is die cast, is typically performed by a trained operator using manual processes that may include iterative steps of measuring, pressing, twisting, hammering, and visual inspection to reach a state of acceptable straightness, i.e., to achieve a part or workpiece that conforms to designed dimensional specifications. Part straightening may be considered an art form that may take six or more months of practice for an operator to become proficient. Further, if a trained operator steps away from straightening work for 1-2 months or longer, it may take up to three days (or more) to resume proficiency. This “time to competency” may be a large hindrance for businesses wanting to increase production, and may also introduce labor inflexibility when businesses want to downscale production and reassign operators to other kinds of work.

The mathematical relationships used to determine bending amounts may not readily apply to new part models or material variations, and it may require a skilled engineer or technician to reestablish or reinforce the mathematical relationships in these situations. If frequent, it is often easier (and less expensive) to employ experienced operators along with manual bending equipment to overcome the variation and deliver a final workpiece that conforms with dimensional specifications.

### SUMMARY

There is a need for an improved system for forming a finished workpiece that conforms to design dimensional specifications, i.e., straightened parts, which may include bending and twisting a workpiece in a manner that reduces part-to-part variability and reduces labor and setup costs.

The concepts described herein provide a system and an apparatus for forming a finished product that conforms with design dimensions, e.g., a straightened part, by bending and/or twisting a workpiece in a manner that reduces part-to-part variability and reduces labor and setup costs.

An aspect of the disclosure may include a system for straightening a workpiece that includes a fabricating machine; a dimensional measurement system; a machine learning module; and a controller, wherein the controller is operatively connected to the fabricating machine and in communication with the dimensional measurement system and the machine learning module. The controller determines a plurality of design dimensions for the workpiece, and determines, via the dimensional measurement system, a plurality of initial dimensional parameters for the workpiece. A plurality of settings for the fabricating machine are determined, via the machine learning module, based upon the plurality of initial dimensional parameters for the workpiece and the plurality of design dimensions for the workpiece. The workpiece is secured into the fixture, and the fabricating machine is arranged employing the plurality of settings. The fabricating machine executes a plurality of operations on the workpiece employing the plurality of settings for the fabricating machine, and the dimensional measurement system verifies that the workpiece exhibits the plurality of design dimensions.

Another aspect of the disclosure may include the controller operating the fabricating machine to determine a plurality of material parameters for the workpiece, and determine, via the machine learning module, the plurality of settings for the fabricating machine based upon the plurality of initial dimensional parameters for the workpiece, the plurality of material parameters for the workpiece, and the plurality of design dimensions for the workpiece.

Another aspect of the disclosure may include the controller operating the fabricating machine to determine, via the dimensional measurement system, the plurality of initial dimensional parameters for the workpiece, wherein the plurality of initial dimensional parameters include at least one of a trueness deviation, a flatness deviation, or a twist deviation from the plurality of design dimensions for the workpiece.

Another aspect of the disclosure may include the controller operating the fabricating machine to execute a plurality of operations on the workpiece employing the plurality of settings for the fabricating machine to transform the workpiece to meet the plurality of design dimensions for the workpiece.

Another aspect of the disclosure may include a human-machine interface system (HMI), the HMI in communication with the controller and the machine learning module; wherein the machine learning module is subjected to a training routine via a plurality of operator inputs to the HMI to determine the plurality of settings for the fabricating machine based upon the plurality of initial dimensional parameters for the workpiece and the plurality of design dimensions for the workpiece.

Another aspect of the disclosure may include a human-machine interface system (HMI), the HMI in communication with the controller and the machine learning module; wherein the machine learning module is subjected to a training routine via a plurality of operator inputs to the HMI to determine the plurality of settings for the fabricating machine based upon the plurality of initial dimensional parameters for the workpiece, the plurality of design dimensions for the workpiece, and a plurality of material parameters for the workpiece.

Another aspect of the disclosure may include the plurality of settings for the fabricating machine being a plurality of bend operation parameters, wherein the plurality of bend operation parameters are determined by the machine learning module based upon the plurality of initial dimensional parameters for the workpiece, the plurality of design dimensions for the workpiece, and the plurality of material parameters for the workpiece.

Another aspect of the disclosure may include the plurality of bend operation parameters being a first bend span, a first lateral bend offset, and a first longitudinal bend offset when the plurality of initial dimensional parameters includes a trueness deviation from the plurality of design dimensions for the workpiece.

Another aspect of the disclosure may include the plurality of bend operation parameters being a second bend span, a second lateral bend offset, and a second longitudinal bend offset when the plurality of initial dimensional parameters includes a flatness deviation from the plurality of design dimensions for the workpiece.

Another aspect of the disclosure may include the plurality of bend operation parameters being a twist level when the plurality of initial dimensional parameters includes a twist deviation from the plurality of design dimensions for the workpiece.

Another aspect of the disclosure may include a workpiece straightening system having a fabricating machine; a dimensional measurement system; a machine learning module; a straightening database; a human-machine interface system (HMI); and a controller. The machine learning module is in communication with the straightening database. The controller is operatively connected to the fabricating machine and in communication with the dimensional measurement system and the machine learning module. The controller executes the following steps on a workpiece: determine a plurality of design dimensions for the workpiece, determine, via the dimensional measurement system, a plurality of initial dimensional parameters for the workpiece, determine, via the machine learning module in communication with the straightening database, a plurality of settings for the fabricating machine based upon the plurality of initial dimensional parameters for the workpiece and the plurality of design dimensions for the workpiece, arrange the fabricating machine employing the plurality of settings, and execute, via the fabricating machine, a plurality of operations on the workpiece employing the plurality of settings for the fabricating machine.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a side view of a workstation including a fabricating machine, in accordance with the disclosure.

FIG. 2 illustrates an isometric view of a workpiece, in accordance with the disclosure.

FIGS. 3A, 3B, and 3C pictorially show a workpiece and associated deviations, in accordance with the disclosure.

FIG. 4 schematically illustrates an overall process for acting on a workpiece, in accordance with the disclosure.

FIG. 5 schematically illustrates a training routine for a machine learning (ML) module for straightening a workpiece, in accordance with the disclosure.

FIG. 6 schematically illustrates a production mode for a machine learning (ML) module for straightening a workpiece, in accordance with the disclosure.

FIG. 7 pictorially illustrates details related to a process setup for executing elements of a training process and a production process that employs a machine learning (ML) module for straightening a workpiece, in accordance with the disclosure.

FIG. 8 pictorially illustrates an HMI screen depicting a first bend operation parameter selection for straightening a workpiece employing a fabricating machine and a machine learning (ML) module, wherein the workpiece has a trueness deviation, in accordance with the disclosure.

FIG. 9 pictorially illustrates an HMI screen depicting a second bend operation parameter selection for straightening a workpiece employing a fabricating machine and a machine learning (ML) module, wherein the workpiece has a flatness deviation, in accordance with the disclosure.

FIG. 10 pictorially illustrates an HMI screen depicting a third bend operation parameter selection for straightening a workpiece employing a fabricating machine and a machine learning (ML) module, wherein the workpiece has a twist deviation, in accordance with the disclosure.

FIG. 11 schematically illustrates inputs to an embodiment of a straightening database for use by a machine learning (ML) module, in accordance with the disclosure.

FIG. 12 schematically illustrates elements related to a machine learning (ML) module, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure.

For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

Embodiments may be described herein in terms of functional and/or logical block components and various processing steps. Such block components may be realized by any number, combination or collection of mechanical and electrical hardware, software, and/or firmware components configured to perform the specified functions. For example, an embodiment of the disclosure may employ various combinations of mechanical components and electrical components, integrated circuit components, memory elements, digital signal processing elements, logic elements, look-up tables, or the like, which may carry out a variety of functions under the control of one or more microprocessors or other control devices. In addition, those skilled in the art will appreciate that the embodiments may be practiced in conjunction with any number of mechanical and/or electronic systems, and that the methods, systems, and apparatuses described herein are merely illustrative of possible implementations.

The use of ordinals such as first, second and third does not necessarily imply a ranked sense of order, but rather may only distinguish between multiple instances of an act or structure.

Referring now to the drawings, a system, method, and apparatus for forming a plurality of finished products from a plurality of workpieces is described that includes a fabricating machine, a dimensional measurement system, a human-machine interface system (HMI), and one or multiple controller(s). The controller is operatively connected to the fabricating machine and in communication with the dimensional measurement system and the HMI.

The concepts described herein may be employed performing mechanical operations on rigid workpieces to ensure the workpieces conform to dimensional specifications. Example rigid workpieces may include, for example, axles, struts, pressed components, driveshafts, etc., which may be fabricated from materials such as aluminum, steel, iron, other metals or alloys thereof. The workpieces may have been fabricated by casting, by forging, by machining, by press-forming, by additive manufacturing, or other processes.

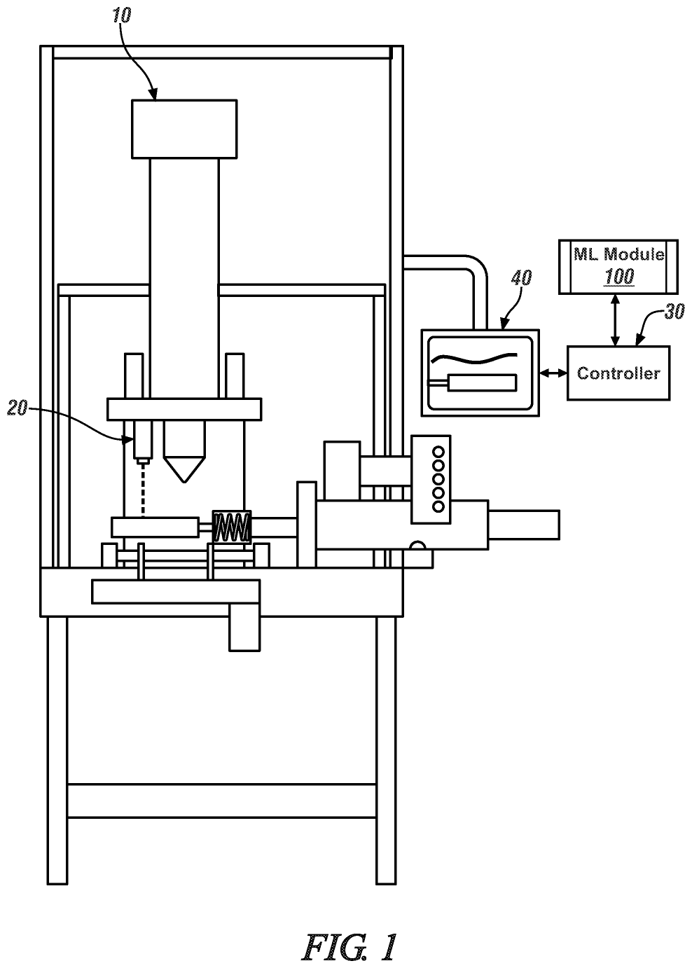

FIG. 1 schematically illustrates a sideview of elements for performing mechanical operations in accordance with the concepts of the disclosure. The relevant elements include a fabricating machine 10, a dimensional measurement system (measurement system) 20, a controller 30, a human-machine interface system (HMI) 40, and a machine learning (ML) module 100.

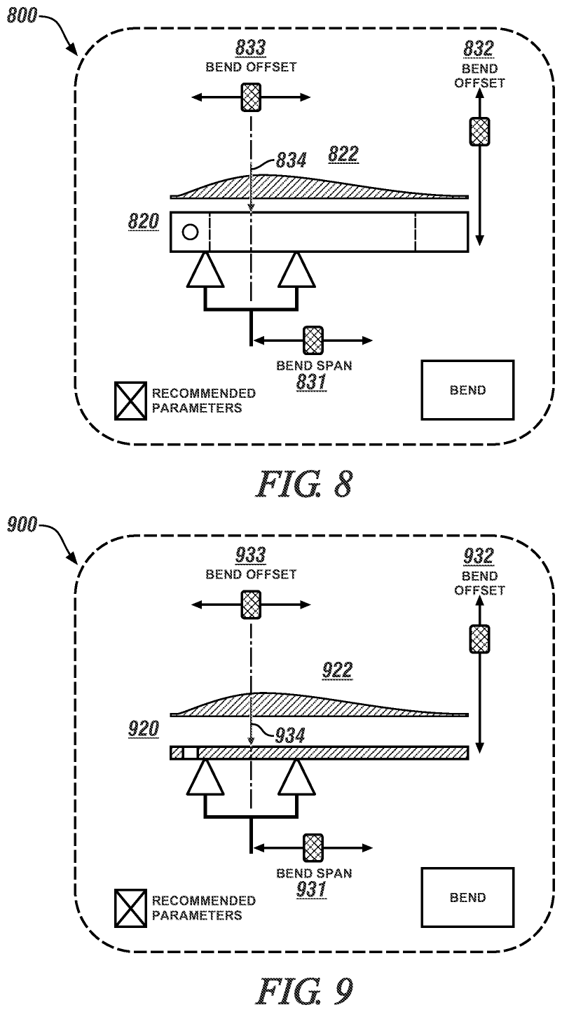

As described herein in further detail, the controller 30 is operatively connected to the fabricating machine 10 and in communication with the measurement system 20, the HMI 40, and the ML module 100. The controller 30 interacts with the measurement system 20 and the ML module 100 to control operation of the fabricating machine 10 to execute steps on a workpiece to ensure the workpiece exhibits or achieves one or multiple design dimensions. Non-limiting examples of deviations from the design dimensions include parameters related to deviations from trueness, flatness, and/or twist of the workpiece, among others. The controller 30 determines, via the measurement system 20, a plurality of initial dimensional parameters for the workpiece, and then determines, via the ML module 100, a plurality of settings for controlling the fabricating machine 10 to act on the workpiece to achieve the one or multiple design dimensions based upon the plurality of initial dimensional parameters for the workpiece. The plurality of settings are composed of bend operation parameters, as described with reference to FIGS. 8, 9, and 10. After securing the workpiece into a fixture on the fabricating machine 10, the controller arranges the fabricating machine 10 employing the plurality of settings and executes, via the fabricating machine 10, one or a plurality of sequential operations on the workpiece employing the plurality of settings. The measurement system 20 verifies that the workpiece exhibits the design dimensions prior to removal of the workpiece from the fixture.

The ML module 100 may be arranged as a stand-alone computing device or system having a CPU or GPU, memory, network connectivity, local storage, and software, in one embodiment. Some or all of the ML module 100 may reside in a cloud-based environment.

The HMI 40 may be configured as a touch panel PC in one embodiment.

The fabricating machine 10, is arranged, in one embodiment, as a self-standing machine configured as a hydraulic press and/or an electromechanical press that is capable of straightening workpieces in the form of metal cast parts. In one embodiment, the workpieces may be arranged as rectangular plates or bars that may be formed by a die cast process such as investment casting. An operator loads a workpiece into the fabricating machine 10, interacts with the fabricating machine 10 via the HMI 40 to inform the fabricating machine 10 of desired straightening operations to perform on the workpiece, and then removes the workpiece from the fabricating machine 10 upon successful straightening or upon a failed straightening determination. This process repeats for a batch of workpieces. Subsequent unique batches of workpieces may be processed repeatedly during an operator shift.

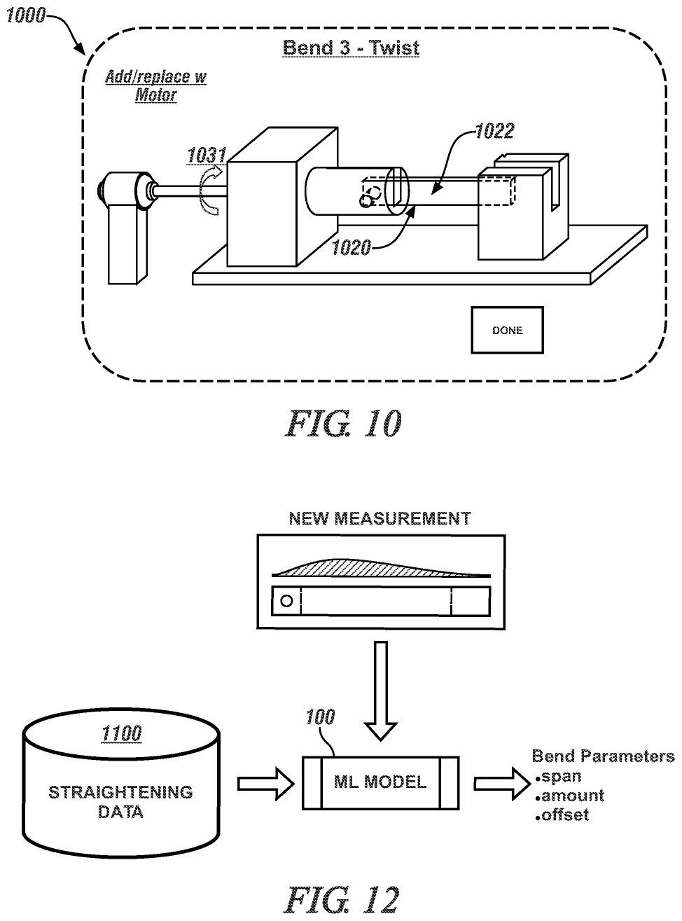

The fabricating machine 10 may include, in one embodiment, a complete steel frame that provides mechanical structure to affix an electro-mechanical or hydraulic press to perform bending operations, a rotating press to provide twisting operations, the HMI 40, and the measurement system 20. Details related to non-limiting examples of bending operations are described with reference to FIGS. 8 and 9. Details related to non-limiting examples of twisting operations are described with reference to FIG. 10.

The electro-mechanical press that performs bending operations on the workpiece may include a moveable bearing block system upon which the workpiece is bent. The rotating press that twists the workpiece may include a twisting system for two separate orientations. The rotating press may also move the workpiece between load/unload position, profile measurement position, and bending position.

Other subsystems may include an electrical power distribution subsystem for motor control, power conversion, and operation of devices; a communication bus related to sensing, data acquisition, and system control; machine/operator safety systems and lockout devices; and supportive functions to operate the fabricating machine 10.

The measurement system 20 may include one or multiple laser sensor(s) that measures the profile of the workpiece in multiple orientations.

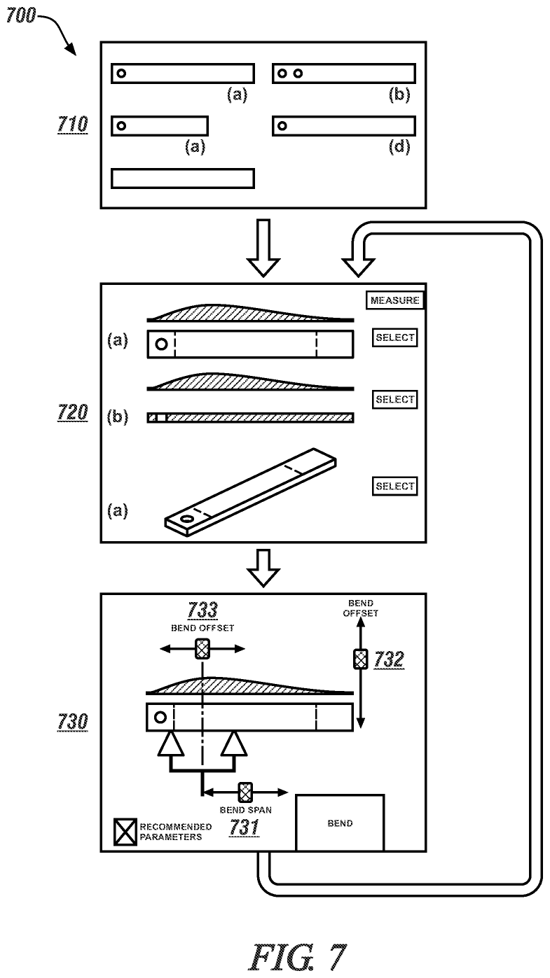

The HMI 40 includes a display that provides a user interface for the operator and to perform computation for some of the machine operation. The HMI 40 may provide access to one or multiple screens to aid the operator in commanding the fabricating machine 10 to perform the straightening, as illustrated and described with reference to FIGS. 7-10.

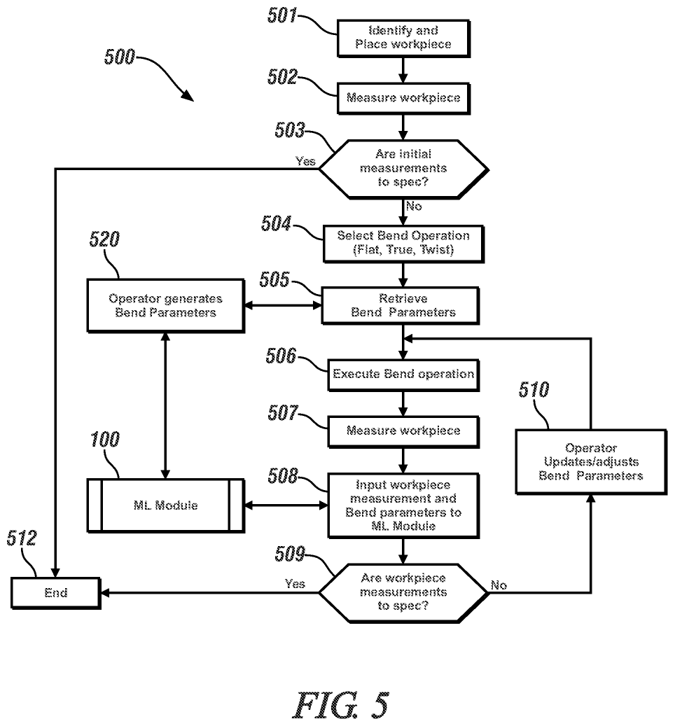

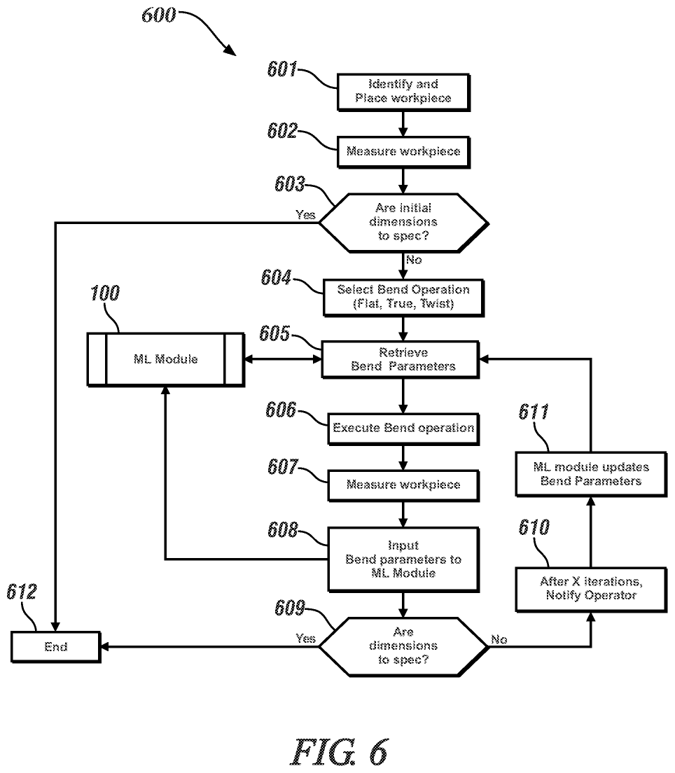

Straightening a workpiece involves one or multiple bending operations with a few basic parameters that are initially determined by a skilled operator during a ML training routine. An example of a ML training routine 500 is described with reference to FIG. 5. Subsequent to setup and operation in the ML training routine 500, straightening of a workpiece may be performed by a less-skilled operator during a production mode employing control parameters that are determined by the ML module 100 for the selected workpiece. An example of a production process 600 is described with reference to FIG. 6.

The process of straightening a part using the machine is iterative and interactive with operator involvement, especially in the training portion of the machine learning module 100 machine using production parts that is described with reference to FIG. 5. As part of a setup procedure in one embodiment, an operator operates the fabricating machine 10 to execute the following steps on a first workpiece: secure the first workpiece into a fixture; determine, via the measurement system 20, a plurality of initial parameters for the first workpiece, including measurements of length, width, and height; and determine design parameters for the first workpiece, including measurement parameters related to addition of at least one of a simple bend, an axial twist, or a complex bend in the form of an s-shape, a u-shape, and an asymmetric bend onto the first workpiece, thus forming the first finished product. The setup operation for the fabricating machine 10 includes executing a plurality of sequential operations on the first workpiece with a plurality of settings on the fabricating machine 10, wherein the fabricating machine is controlled to transform the first workpiece to have the design dimensions. The controller 30 captures the plurality of sequential operations and the plurality settings executed by the fabricating machine 10 on the first workpiece during the setup operation. The measurement system 20 verifies that the workpiece exhibits the design dimensions after execution of the setup operation.

The controller 30 operates the fabricating machine 10 to execute the following steps on a second and subsequent workpieces: secure the second workpiece into the fixture; determine, via the measurement system 20, a plurality of initial parameters for the second workpiece, including measurements of length, width, and height; and execute the plurality of sequential operations on the second workpiece with the plurality of settings on the fabricating machine, wherein the fabricating machine is controlled to transform the second workpiece having the design dimensions. The measurement system 20 verifies that the second workpiece and ensuing workpieces exhibit the design dimensions.

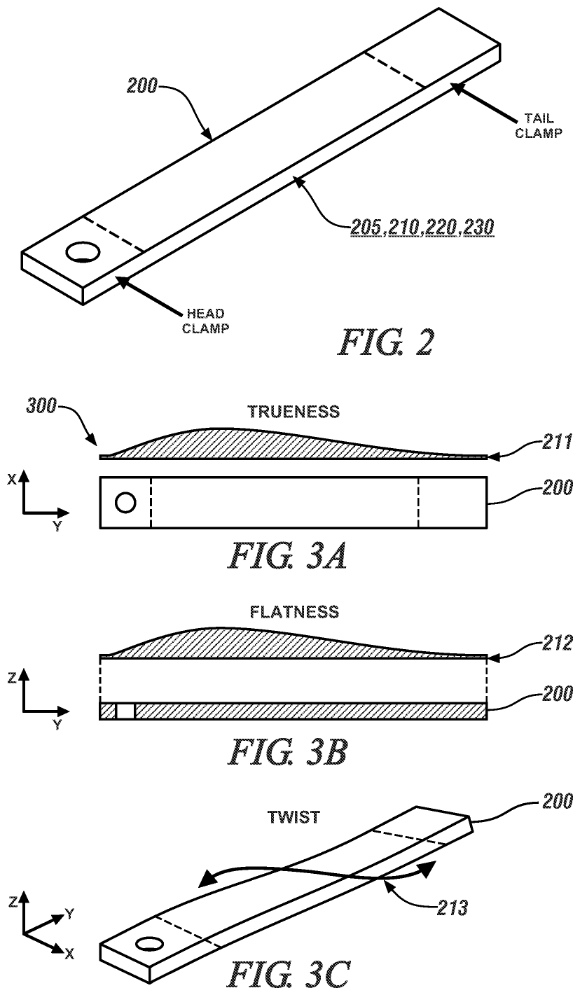

FIG. 2 provides a 3D isometric illustration of an example of a workpiece 200 upon which the straightening operations described herein may be performed. In one embodiment, and as shown, the workpiece 200 is configured as an elongated rectangular prism having a design specification that includes a plurality of design dimensions 205. The plurality of design dimensions 205 may be in the form of x,y,z dimensions that are defined in relation to a lateral axis x, a longitudinal axis y, and an elevation axis z. The workpiece 200 may be a solid elongated workpiece that is fabricated as an extruded/drawn bar, a hot-rolled or cold-rolled bar, a forged bar, a stamped bar, etc. The workpiece 200 may be fabricated from an additive manufacturing process in one embodiment. The workpiece 200 may be formed from a material that includes steel, iron, aluminum, titanium, alloys thereof, etc.

A plurality of initial dimensional parameters 210 for the workpiece 200 may also be determined using the measurement system 20 described with reference to FIG. 1. The workpiece 200 also has a first plurality of material parameters 220 that are based upon the materials, i.e., one of steel, iron, aluminum, titanium, alloys thereof, etc. The workpiece 200 also has a second plurality of material parameters 230 that are based upon the workpiece fabrication process, i.e., one of extrusion or drawing, hot-rolling, cold-rolling, forging, stamping, additive manufacturing, etc.

Visual depictions of workpiece 200 with a plurality of deviations 300, include a trueness deviation 211 that is illustrated with reference to FIG. 3A, a flatness deviation 212 that is illustrated with reference to FIG. 3B, and twist deviation 213 that is illustrated with reference to FIG. 3C, which are shown with reference to the lateral axis x, longitudinal axis y, and elevation axis z.

FIG. 3A schematically illustrates a top view of the workpiece 200 in the xy plane, and an associated depiction of trueness deviation 211, which is indicated by hatched lines that are projecting from the y-axis. Trueness deviation 211 is defined and described as a linear deviation in the x-dimension from a longitudinal side edge line that is defined by the design specification for the workpiece 200.

FIG. 3B schematically illustrates a side view of the workpiece 200 in the yz plane, and an associated depiction of flatness deviation 212, which is indicated by hatched lines that are projecting from the z-axis. Flatness deviation 212 is defined and described as a linear deviation in the z-dimension from a longitudinal top edge line that is defined by the design specification for the workpiece 200.

FIG. 3C schematically illustrates an isometric view of the workpiece 200, and an associated depiction of twist deviation 213, which is indicated by an arrow. Twist deviation 213 is defined and described as a rotational deviation, in degrees of rotation, in the xz plane from a front edge that is defined by the design specification for the workpiece 200.

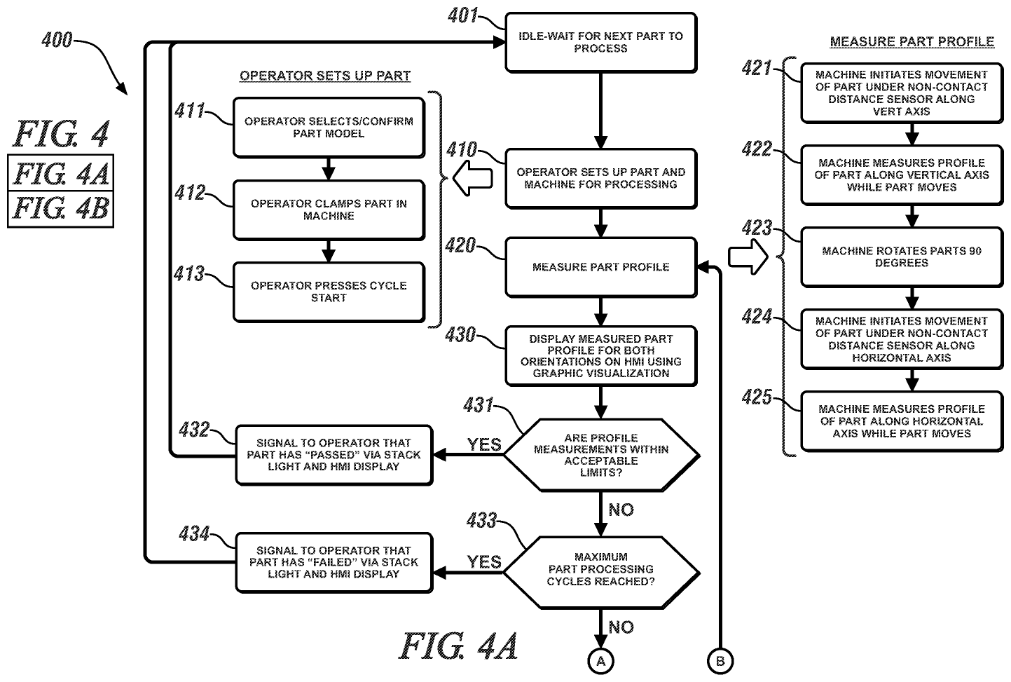

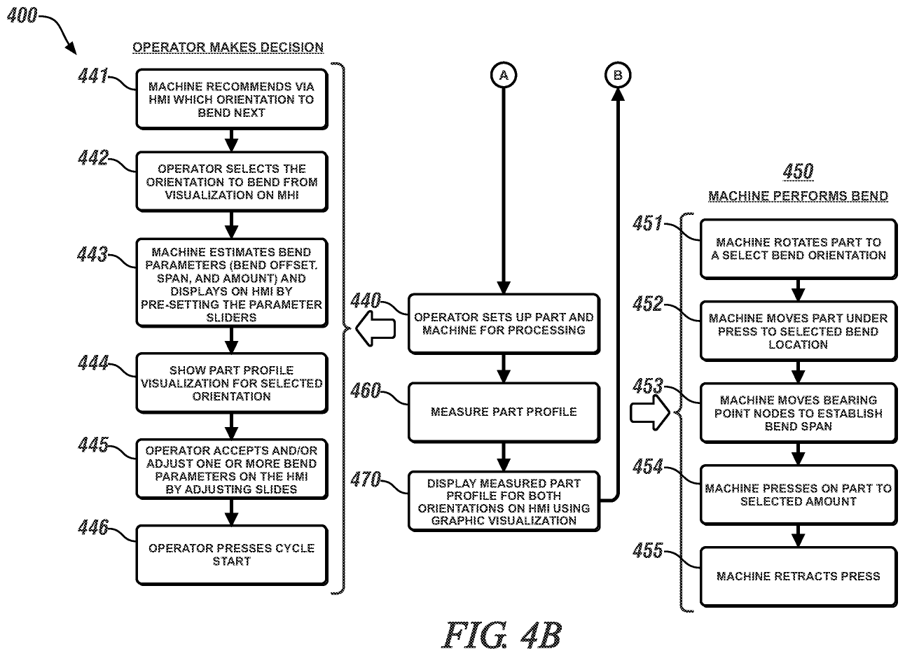

FIG. 4, which is composed of FIGS. 4A and 4B, schematically illustrates elements of an overall process 400 for acting on a workpiece, e.g., the workpiece 200 described with reference to FIGS. 2, 3A, 3B, and 3C, to achieve design dimensions employing an embodiment of the fabricating machine 10 that is described with reference to FIG. 1. The controller 30 determines, via the measurement system 20, a plurality of initial dimensional parameters for the workpiece 200, and then determines, via the ML module 100, a plurality of settings, e.g., bend operating parameters, for controlling the fabricating machine 10 to act on the workpiece 200 to achieve the one or multiple design dimensions based upon the plurality of initial dimensional parameters for the workpiece. After securing the workpiece into a fixture on the fabricating machine 10, the controller 30 arranges the fabricating machine 10 employing the plurality of settings and executes, via the fabricating machine 10, one or a plurality of sequential operations on the workpiece 200 employing the plurality of settings. The measurement system 20 verifies that the workpiece 200 exhibits the design dimensions prior to removal of the workpiece from the fixture.

The process 400 is idle while waiting for a workpiece (part) (Step 401). When a workpiece is selected, the workpiece is setup for processing (Step 410), which includes selecting or confirming a part model (Step 411), inserting and clamping the workpiece into the fabricating machine 10 (Step 412) and initiating a cycle start (Step 413).

A part profile measurement by the measurement system 20 is initiated to determine a plurality of initial dimensional parameters for the workpiece 200 (Step 420). This includes moving the workpiece under the measurement system 20 to determine measurement along the z-axis (vertical) axis (Steps 421, 422), and then rotating the workpiece 90° (Step 423) and moving the workpiece under the measurement system 20 to determine measurement along the x-axis (lateral) axis (Steps 424, 425). The resulting measurements, depicted as trueness deviation 211, flatness deviation 212, and twist deviation 213 with reference to FIGS. 3A, 3B, and 3C may be visually displayed on the HMI 40 (Step 430).

When all of the profile measurements are within acceptable limits in relation to specifications (Step 431)(Yes), the operator is signaled via the HMI 40 that the workpiece 200 has passed (Step 432) and this iteration ends with the workpiece being removed and placed in a queue for further processing.

When one or more of the profile measurements are not within acceptable limits in relation to specifications (Step 431)(No), the controller determines whether a maximum quantity of attempts has been achieved (Step 433).

When a maximum quantity of attempts has been achieved (Step 433)(Yes), the operator is signaled via the HMI 40 that the workpiece 200 has not passed (Step 434), and this iterations with the workpiece 200 being removed and scrapped.

When a maximum quantity of attempts has not been achieved (Step 433)(No), the workpiece is set up for machine-based straightening (Step 440).

The machine-based straightening (Step 440) includes recommending a bend orientation (Step 441), selecting the bend orientation (Step 442), estimating or otherwise determining bend parameters for the orientation (Step 443), visually displaying the part (Step 444), accepting all of the bend parameters, or adjusting one or more of the bend parameters (Step 445), and starting and executing the bend process 450 (Step 446).

The bend process 450 is executed and includes rotating the workpiece 200 to the selected bend orientation (Step 451), and moving the workpiece 200 to a selected bend location (Step 452), and moving bearing point nodes to establish a bend span (Step 453). The fabricating machine 10 exerts, via a hydraulic press, a predetermined magnitude of force on the workpiece 200 at a defined location (Step 454), and then retracts the hydraulic press (Step 455).

After the bend process 450 is completed, the workpiece 200 is measured via the measurement system 20 (Step 460) and the initial dimensions are displayed on the HMI 40 and captured by the controller (Step 470), and provided as feedback to Step 420.

This process 400 may be repeated for each of the initial dimensions that are outside of dimensional tolerance in relation to the design dimensions, i.e., each of the trueness deviation 211, flatness deviation 212, and twist deviation 213 that are described with reference to FIG. 3 that are outside of dimensional tolerance.

This process 400 is enhanced by implementation of machine learning methodologies, which serve to reduce variation, reduce errors, improve cycle times, and improve productivity.

Machine learning is a subfield of artificial intelligence, which is broadly defined as the capability of a machine to imitate intelligent human behavior. Artificial intelligence systems are used to perform complex tasks in a way that is similar to how humans solve problems. This includes teaching operating skills to a ML module without explicit programming steps. A machine learning system may be descriptive—use data parameters (before and after), predictive, and/or prescriptive.

The machine learning system may be descriptive, meaning that the system uses the data to explain what happened. The machine learning system may be predictive, meaning the system uses the data to predict what will happen. The machine learning system may be prescriptive, meaning the system will use the data to make suggestions about what action to take.

Supervised machine learning models are trained with labeled data sets, which allow the models to learn and grow more accurate over time.

Reinforcement machine learning trains machines through trial and error to take the best action by establishing a reward system. Reinforcement learning may train models by telling the machine when it made the right decisions, which helps it learn over time what actions it must take to effect straightening.

In context of the process 400, including the ML training routine 500 and the production process 600, machine learning is accomplished by capturing and recording all part profile measurements, operator decisions, and actual part profile measurements after bends are made. This recorded information is used to update a mathematical model, using machine learning and AI methods, with every workpiece. The mathematical model is employed to estimate bend parameters for subsequent parts being straightened. This concept facilitates employing an experienced operator to train the machine on how to straighten various families of parts. With enough training time, the ML module progressively becomes capable of straightening parts without human guidance. This allows the use of non-skilled operators, or even robotics, to tend the fabricating machine 10 with minimal amounts of operator input. Operators may also tend the machine while performing other manufacturing tasks, thus increasing their productivity.

FIGS. 5 and 6 schematically illustrate details related to the ML module 100. FIG. 5 schematically illustrates details related to training of the ML module 100 and FIG. 6 schematically illustrates details related to implementation of the ML module 100 to effect straightening of workpieces with minimal operator input.

The training and implementation of the ML module 100 to effect straightening of workpieces with minimal operator input includes determining, via the machine learning module, a plurality of settings for the fabricating machine based upon initial dimensional parameters for the workpiece, the material parameters for the workpiece, and design dimensions for the workpiece. The machine learning module 100 determines a plurality of settings for the fabricating machine 10 based upon the initial dimensional parameters for the workpiece, the material parameters for the workpiece, and the plurality of design dimensions for the workpiece. After securing the workpiece into a fixture, the fabricating machine 10 is configured based upon the plurality of settings and executes one or multiple operations employing the plurality of settings for the fabricating machine to effect straightening of the workpiece, wherein the straightening may be determined in relation to a trueness deviation, a flatness deviation, and/or a twist deviation of the workpiece from a design dimension. The measurement system 20 verifies that the workpiece exhibits the design dimensions prior to ending the process.

Referring again to FIG. 5, the ML training routine 500 for the ML module 100 includes as follows. The ML training routine 500 is executed by the controller 30, which communicates with the ML module 100 to control the fabricating machine 10 to straighten a workpiece. During execution of the ML training routine 500, there may be one or multiple interactions with an operator via the HMI 40 that is skilled in the art of part straightening. The ML module 100 is subjected to the training routine 500 via a plurality of operator inputs to the HMI to determine the plurality of settings for the fabricating machine 10 to effect straightening of the workpiece based upon the plurality of initial dimensional parameters for the workpiece and the plurality of design dimensions for the workpiece.

Initially, a workpiece is identified and placed in the fabricating machine 10 (Step 501). The workpiece may be identified by the operator or may be identified by a unique tag, e.g., a bar code or a QR code, to determine material parameters and the design specification including the plurality of design dimensions 205 corresponding to the workpiece. The material parameters and design specification corresponding to the workpiece are preferably stored in a memory device that is accessible to the controller 30.

The workpiece is subjected to dimensional measurement by the measurement system 20 to determine the initial dimensional parameters 210 (Step 502).

When the dimensional measurement of the workpiece indicates that the initial dimensional parameters 210 of the workpiece meet the design specifications for the workpiece (Step 503)(Yes), no further action is necessary, and this iteration ends (Step 512).

When the measurement of the workpiece indicates that one or more of the initial dimensional parameters 210 of the workpiece do not meet or otherwise conform to the design specifications for the workpiece (Step 503)(No), a bend operation is selected by the operator via the HMI 40 (Step 504). In one embodiment, the one or more of the initial dimensional parameters 210 of the workpiece that do not meet the design specifications may be identified via the HMI 40 in relation to trueness, flatness and/or twist of the workpiece.

The selected bend operation may be a straightening operation that is defined by trueness, flatness or twist of the workpiece, and includes bend operation parameters in the form of a plurality of settings for the fabricating machine 10 that are based upon the initial dimensional parameters 210 for the workpiece, the material parameters for the workpiece, and the plurality of design dimensions for the workpiece.

During the training process, the bend operation parameters are retrieved (Step 505), with the bend operation parameters initially having been generated by the operator (Step 520). The bend operation parameters generated by the operator are also input to the ML Module 100.

The bend operation parameters are in the form of one or a plurality of settings for the fabricating machine 10 to bend the workpiece to effect straightening thereof. Examples of bend operation parameters in the form of one or a plurality of settings for the fabricating machine 10 are described with reference to FIGS. 8, 9, and 10.

After retrieving the bend operation parameters, the fabricating machine 10 implements the bend operation parameters that are generated by the operator and executes one or multiple bend operations to straighten the workpiece (Step 506) and the workpiece is measured with the measurement system 20 (Step 507).

The initial dimensional parameters as measured at Step 502, the material parameters and design specification corresponding to the workpiece, the final workpiece measurements as measured at step 507, the bend operation parameters generated by the operator, and the bend operation parameters executed by the fabricating machine 10 are input to the ML module 100 for training and analysis (Step 508).

The final workpiece measurements as measured at step 507 are evaluated to verify whether they meet the design specification for the workpiece (Step 509).

When the final workpiece measurements as measured at step 507 meet the design specification for the workpiece (Step 509)(Yes), no further action is necessary, and this iteration ends (Step 512).

When the final workpiece measurements as measured at step 507 do not meet the design specification for the workpiece (Step 509)(No), the operator adjusts one or more of the bend parameters (Step 510), and re-executes steps 506 through 509.

The ML training routine 500 for the ML module 100 may be executed on any quantity of workpieces having the same design specification in the form of material parameters and design dimensions.

Referring again to FIG. 6, a production process 600 that employs the ML module 100 includes as follows. The production process 600 is executed by the controller 30, which communicates with the ML module 100 to control the fabricating machine 10 to straighten a workpiece. During execution of the production process 600, there may be minimal interactions with an operator.

Initially, a workpiece is identified and placed in the fabricating machine 10 (Step 601). The workpiece may be identified by the operator or may be identified by a unique tag, e.g., a bar code or a QR code, to determine material parameters and design specification corresponding to the workpiece. The material parameters and design specification corresponding to the workpiece are preferably stored in a memory device that is accessible to the controller 30.

The workpiece is subjected to dimensional measurement by the measurement system 20 (Step 602).

When the dimensional measurement of the workpiece indicates that the initial measurements of the workpiece meet the design specification for the workpiece (Step 603)(Yes), no further action is necessary and this iteration ends (Step 612).

When the measurement of the workpiece indicates that one or more of the dimensions of the workpiece do not meet the design specification for the workpiece (Step 603)(No), a bend operation is selected by the controller 30 (Step 604). In one embodiment, the one or more of the dimensions of the workpiece that do not meet the design specification for the workpiece may be identified in relation to trueness, flatness and/or twist of the workpiece.

The selected bend operation may be a straightening operation that is defined by trueness, flatness or twist of the workpiece, and includes bend operation parameters in the form of a plurality of settings for the fabricating machine 10 that are based upon the initial dimensional parameters for the workpiece, the material parameters for the workpiece, and the plurality of design dimensions for the workpiece.

During the production process, the bend operation parameters are retrieved from the ML module 100 (Step 605).

The bend operation parameters are in the form of one or a plurality of settings for the fabricating machine 10 to bend the workpiece to effect straightening thereof, with the straightening associated with at least one of trueness, flatness, or twist. Examples of bend operation parameters in the form of one or a plurality of settings for the fabricating machine 10 are described with reference to FIGS. 8, 9, and 10.

After retrieving the bend operation parameters, the fabricating machine 10 implements the bend operation parameters and executes one or multiple bend operations to straighten the workpiece (Step 606) and the workpiece is measured with the measurement system 20 (Step 607).

The initial workpiece measurements as measured at Step 602, the material parameters and design dimensions corresponding to the workpiece, the final workpiece measurements as measured at step 607, the bend operation parameters generated by the ML module 100, and the bend operation parameters executed by the fabricating machine 10 are input to the ML module 100 for training, analysis, and refinement (Step 608).

The final workpiece measurements as measured at step 607 are evaluated to verify whether they meet the design dimensions for the workpiece (Step 609).

When the final workpiece measurements as measured at step 607 meet the design dimensions for the workpiece (Step 609)(Yes), no further action is necessary and this iteration ends (Step 612).

When the final workpiece measurements as measured at step 607 do not meet the design dimensions for the workpiece (Step 609)(No), the controller 30 verifies whether a predetermined quantity of iterations have been executed on the specific workpiece (Step 610). If so, the process stops (Step 612), with further action including scrapping the specific workpiece or further evaluation of the operation of the fabricating machine 10.

Otherwise, one or more of the bend parameters are updated by the ML module 100 (Step 611), and another iteration of Steps 605-609 is executed.

The production process 600 for the ML module 100 may be executed on any quantity of workpieces having the same design specifications in the form of material parameters and the design dimensions.

FIG. 7 schematically illustrates a process setup 700 for executing the ML training routine 500 for the ML module 100 (as described with reference to FIG. 5) or executing production process 600 that employs the ML module 100 (as described with reference to FIG. 6). The process setup 700 includes workpiece selection step 710, straightening process selection step 720, and bend operation parameter selection step 730.

The workpiece selection step 710 includes selecting and identifying one of a plurality of workpieces, indicated as (a), (b), (c), (d), or (e). Each of the plurality of workpieces has a design specification that includes a plurality of material parameters and design dimensions.

The straightening process selection step 720 includes selecting one of a trueness deviation (a), a flatness deviation (b), or a twist deviation (c) of the workpiece based upon initial measurements.

The bend operation parameter selection step 730 includes the ML module 100 selecting a plurality of bend operation parameters in the form of a plurality of settings for the fabricating machine 10 that are based upon the initial dimensional parameters for the workpiece, the material parameters for the workpiece, and the plurality of design dimensions for the workpiece to effect straightening thereof, with the straightening associated with at least one of trueness, flatness, or twist. As shown, the plurality of settings for the fabricating machine 10 include a bend span 731, a lateral bend offset 732, and a longitudinal bend offset 733, for a trueness bend operation. Example HMI screen displays for trueness, flatness, and twist are described with reference to FIGS. 8, 9, and 10, respectively.

FIG. 8 illustrates an HMI screen depicting a first bend operation parameter selection 800 that includes a plurality of settings for the fabricating machine 10 that are selected by the ML module 100 based upon the initial dimensional parameters for workpiece 820, wherein workpiece 820 has a trueness deviation 822. The fabricating machine 10 includes a moveable bearing block system in one embodiment. The plurality of settings for the fabricating machine 10 that are based upon the initial dimensional parameters for workpiece 820 having the trueness deviation 822 also incorporate and account for the material parameters for the workpiece, and the plurality of design dimensions for the workpiece. As shown, workpiece 820 is arranged for a trueness bend operation and the plurality of settings for the fabricating machine 10 include a first bend span 831, a first lateral bend offset 832, a first longitudinal bend offset 833, and a first mechanical force 834, which are selected and applied to the moveable bearing block system to eliminate the trueness deviation 822. The fabricating machine 10 exerts the first mechanical force 834 having a predetermined magnitude on the workpiece 820 at a point corresponding to the first longitudinal bend offset 833 to overcome or eliminate the trueness deviation 822.

FIG. 9 illustrates an HMI screen depicting a second bend operation parameter selection 900 that includes a plurality of settings for the fabricating machine 10 that are selected by the ML module 100 based upon the initial dimensional parameters for workpiece 920, wherein workpiece 920 has a flatness deviation 922. The plurality of settings for the fabricating machine 10 that are based upon the initial dimensional parameters for workpiece 920 having the flatness deviation 922 also incorporate and account for the material parameters for the workpiece, and the plurality of design dimensions for the workpiece. As shown, workpiece 920 is arranged for a flatness bend operation and the plurality of settings for the fabricating machine 10 include a second bend span 931, a second lateral bend offset 932, a second longitudinal bend offset 933, and a second mechanical force 934, which are selected and applied to the moveable bearing block system to eliminate the flatness deviation 922. The fabricating machine 10 exerts the second mechanical force 934 having a predetermined magnitude on the workpiece 920 at a point corresponding to the second longitudinal bend offset 933 to overcome or eliminate the flatness deviation 922.

FIG. 10 illustrates an HMI screen depicting a third bend operation parameter selection 1000 that includes a plurality of settings for the fabricating machine 10 that are selected by the ML module 100 based upon the initial dimensional parameters for workpiece 1020, wherein workpiece 1020 has a twist deviation 1022. The fabricating machine 10 includes a rotating press, and the plurality of settings for the fabricating machine 10 are based upon the initial dimensional parameters for workpiece 1020 having the twist deviation 1022 also incorporate and account for the material parameters for the workpiece, and the plurality of design dimensions for the workpiece 1020. As shown, workpiece 1020 is arranged for a twist bend operation and the plurality of settings for the fabricating machine 10 include a twist force 1031 for the rotating press, in degrees of rotation, which is selected to eliminate the twist deviation 1022.

The fabricating machine 10 exerts the twist force 1031 having a predetermined magnitude on one end of the workpiece 1020 to overcome or eliminate the twist deviation 1022.

FIG. 11 schematically illustrates an embodiment of a straightening database 1100, which captures and provides data to the ML Module 100 for purposes of training (described with reference to the ML training routine 500 of FIG. 5) and in-use operation (described with reference to production process 600 of FIG. 6).

Inputs to the straightening database (Straightening Data) 1100 include details related to each of a plurality or multiplicity of workpieces 200, which includes the plurality of design dimensions 205, the initial dimensional parameters 210, the first plurality of material parameters 220, and the second plurality of material parameters 230. Inputs to the straightening database 1100 also include the plurality of deviations 300, including trueness deviation 211, a flatness deviation 212, and a twist deviation 213. The inputs to the straightening database 1100 also include the first bend operation parameter selection 800 that is described with reference to FIG. 8, which includes a plurality of settings for the fabricating machine 10 that are based upon the initial dimensional parameters for workpiece 820, wherein workpiece 820 has a trueness deviation 822. The inputs to the straightening database 1100 also include the second bend operation parameter selection 900 that is described with reference to FIG. 9, which includes a plurality of settings for the fabricating machine 10 that are based upon the initial dimensional parameters for workpiece 920, wherein workpiece 920 has a flatness deviation 922. The inputs to the straightening database 1100 also include the third bend operation parameter selection 1000 that is described with reference to FIG. 10, which includes a plurality of settings for the fabricating machine 10 that are based upon the initial dimensional parameters for workpiece 1020, wherein workpiece 1020 has a twist deviation 1022.

The straightening database 1100 may be integrated into a memory device of the ML module 100, or may reside in an external memory device, including residing in a cloud-storage system.

The straightening database 1100 may include the aforementioned data that is captured from a single fabricating machine 10 in one embodiment. The straightening database 1100 may include the aforementioned data that is captured from a plurality of the fabricating machines 10 that are employed in operating on a single workpiece design in one embodiment. The straightening database 1100 may include the aforementioned data that is captured from a plurality of the fabricating machines 10 that are employed in operating on a multiple workpiece designs in one embodiment.

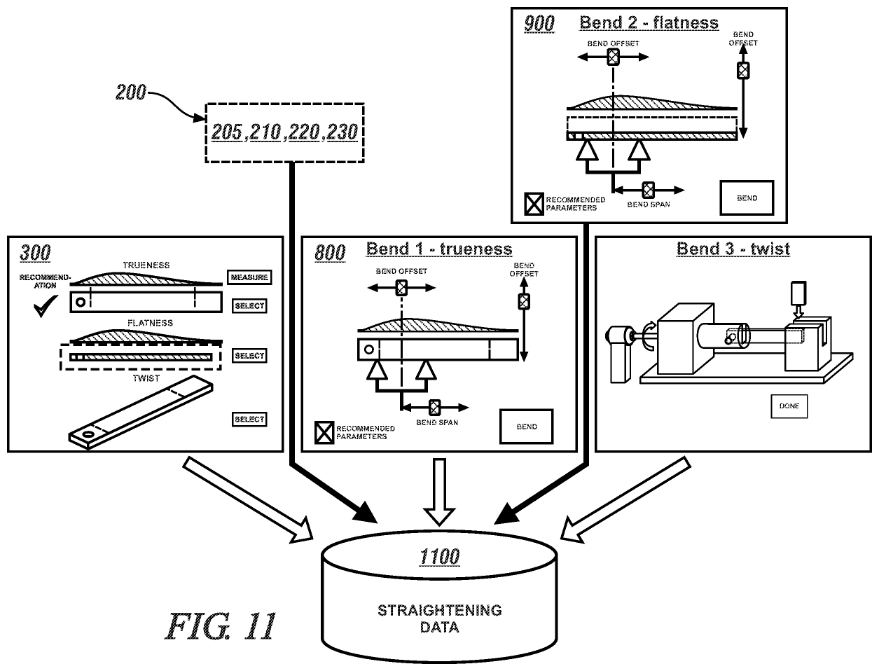

FIG. 12 pictorially illustrates elements related to training and employing an embodiment of the machine learning (ML) module 100 to determine a plurality of settings in the form of bend operation parameters for the fabricating machine 10 based upon the plurality of initial dimensional parameters for the workpiece and the plurality of design dimensions 205 for the workpiece. The straightening database 1100 provides data input to the ML Module 100, which executes machine learning protocols to determine suggested bend parameters for a workpiece based upon measurement input.

By implementing an embodiment of the machine learning (ML) module 100 to determine a plurality of settings in the form of bend operation parameters for the fabricating machine 10 based upon the plurality of initial dimensional parameters for the workpiece and the plurality of design dimensions 205 for the workpiece, a skilled operator may train the system in real time with data derived from straightening actual workpieces, and a less skilled operator may operate the system as quickly as skilled operators. The overall result is an increased throughput for one work cell as compared to an unimproved system. Furthermore, after the fabricating machine is trained, a single operator may run multiple fabricating machines at the same time for increased throughput and scalability.

These concepts include the application of machine learning and AI to train a machine using an experienced operator, where the machine automatically builds a mathematical model relating the measurement of the part to bending operations necessary to straighten the part.

These concepts enable a skilled operator's experience to be digitalized via machine learning and AI techniques, including bending parts with non-uniform cross-sections or non-uniform materials.

An advantage of the concept is that it may learn a straightening process from a skilled operator and use this learned information to perform straightening automatically. The concept also leads to increased throughput in manufacturing parts because operator decision-making, part handling, and operator error are greatly minimized. It is also possible to use a second, third, and so on, machine that uses the same trained mathematical model to also straighten parts. This makes it easy to scale production without having additional skilled operators on hand.

The term “controller” and related terms such as microcontroller, control, control unit, processor, module, etc. refer to one or various combinations of Application Specific Integrated Circuit(s) (ASIC), Field-Programmable Gate Array(s) (FPGA), electronic circuit(s), central processing unit(s), e.g.,, microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter may have a discrete vale.g., e.g., either “1” or “0”, or may be infinitely variable in value.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects. Furthermore, the present disclosure may take the form of a computer program product embodied in a tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in a combination of one or more programming languages.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that may direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A system for straightening a workpiece, comprising:
a fabricating machine;
a dimensional measurement system;
a machine learning module; and
a controller, the controller operatively connected to the fabricating machine and in communication with the dimensional measurement system and the machine learning module;
wherein the controller executes the following steps:
determine a plurality of design dimensions for the workpiece,
determine, via the dimensional measurement system, a plurality of initial dimensional parameters for the workpiece,
determine, via the machine learning module, a plurality of settings for the fabricating machine based upon the plurality of initial dimensional parameters for the workpiece and the plurality of design dimensions for the workpiece,
secure the workpiece into a fixture of the fabricating machine,
arrange the fabricating machine employing the plurality of settings,
execute, via the fabricating machine, a plurality of operations on the workpiece employing the plurality of settings for the fabricating machine, and
verify, via the dimensional measurement system, that the workpiece exhibits the plurality of design dimensions.

2. The system of claim 1, further comprising the controller operating the fabricating machine to execute the following steps on the workpiece:
determine a plurality of material parameters for the workpiece, and
determine, via the machine learning module, the plurality of settings for the fabricating machine based upon the plurality of initial dimensional parameters for the workpiece, the plurality of material parameters for the workpiece, and the plurality of design dimensions for the workpiece.

3. The system of claim 1, further comprising the controller operating the fabricating machine to execute the following steps on the workpiece:
determine, via the dimensional measurement system, the plurality of initial dimensional parameters for the workpiece, wherein the plurality of initial dimensional parameters include at least one of a trueness deviation, a flatness deviation, or a twist deviation from the plurality of design dimensions for the workpiece.

4. The system of claim 1, wherein the controller operates the fabricating machine to execute a plurality of operations on the workpiece employing the plurality of settings for the fabricating machine to transform the workpiece to meet the plurality of design dimensions for the workpiece.

5. The system of claim 1, further comprising a human-machine interface system (HMI), the HMI in communication with the controller and the machine learning module; wherein the machine learning module is subjected to a training routine via a plurality of operator inputs to the HMI to determine the plurality of settings for the fabricating machine based upon the plurality of initial dimensional parameters for the workpiece and the plurality of design dimensions for the workpiece.

6. The system of claim 1, further comprising a human-machine interface system (HMI), the HMI in communication with the controller and the machine learning module; wherein the machine learning module is subjected to a training routine via a plurality of operator inputs to the HMI to determine the plurality of settings for the fabricating machine based upon the plurality of initial dimensional parameters for the workpiece, the plurality of design dimensions for the workpiece, and a plurality of material parameters for the workpiece.

7. The system of claim 6, wherein the plurality of settings for the fabricating machine comprises a plurality of bend operation parameters, wherein the plurality of bend operation parameters are determined by the machine learning module based upon the plurality of initial dimensional parameters for the workpiece, the plurality of design dimensions for the workpiece, and the plurality of material parameters for the workpiece.

8. The system of claim 7, wherein the plurality of bend operation parameters comprises a first bend span, a first lateral bend offset, and a first longitudinal bend offset when the plurality of initial dimensional parameters includes a trueness deviation from the plurality of design dimensions for the workpiece.

9. The system of claim 7, wherein the plurality of bend operation parameters comprises a second bend span, a second lateral bend offset, and a second longitudinal bend offset when the plurality of initial dimensional parameters includes a flatness deviation from the plurality of design dimensions for the workpiece.

10. The system of claim 7, wherein the plurality of bend operation parameters comprises a twist level when the plurality of initial dimensional parameters includes a twist deviation from the plurality of design dimensions for the workpiece.

11. A workpiece straightening system, comprising:
a fabricating machine;
a dimensional measurement system;
a machine learning module;
a straightening database; and
a controller;
the machine learning module being in communication with the straightening database;
the controller operatively connected to the fabricating machine and in communication with the dimensional measurement system and the machine learning module;
wherein the controller executes the following steps on a workpiece:
determine a plurality of design dimensions for the workpiece,
determine, via the dimensional measurement system, a plurality of initial dimensional parameters for the workpiece,
determine, via the machine learning module in communication with the straightening database, a plurality of settings for the fabricating machine based upon the plurality of initial dimensional parameters for the workpiece and the plurality of design dimensions for the workpiece,
arrange the fabricating machine employing the plurality of settings, and
execute, via the fabricating machine, a plurality of operations on the workpiece employing the plurality of settings for the fabricating machine.

12. The system of claim 11, further comprising the controller operating the fabricating machine to execute the following steps on the workpiece:
determine a plurality of material parameters for the workpiece, and
determine, via the machine learning module, the plurality of settings for the fabricating machine based upon the plurality of initial dimensional parameters for the workpiece, the plurality of material parameters for the workpiece, and the plurality of design dimensions for the workpiece.

13. The system of claim 11, further comprising the controller operating the fabricating machine to execute the following steps on the workpiece:
determine, via the dimensional measurement system, the plurality of initial dimensional parameters for the workpiece, wherein the plurality of initial dimensional parameters include at least one of a trueness deviation, a flatness deviation, or a twist deviation from the plurality of design dimensions for the workpiece.

14. The system of claim 11, wherein the controller operates the fabricating machine to execute a plurality of operations on the workpiece employing the plurality of settings for the fabricating machine to transform the workpiece to meet the plurality of design dimensions for the workpiece.

15. The system of claim 11, further comprising a human-machine interface system (HMI), the HMI in communication with the controller and the machine learning module; wherein the machine learning module is subjected to a training routine via a plurality of operator inputs to the HMI to determine the plurality of settings for the fabricating machine based upon the plurality of initial dimensional parameters for the workpiece and the plurality of design dimensions for the workpiece.

16. The system of claim 11, further comprising a human-machine interface system (HMI), the HMI in communication with the controller and the machine learning module; wherein the machine learning module is subjected to a training routine via a plurality of operator inputs to the HMI to determine the plurality of settings for the fabricating machine based upon the plurality of initial dimensional parameters for the workpiece, the plurality of design dimensions for the workpiece, and a plurality of material parameters for the workpiece.

17. The system of claim 16, wherein the plurality of settings for the fabricating machine comprises a plurality of bend operation parameters, wherein the plurality of bend operation parameters are determined by the machine learning module based upon the plurality of initial dimensional parameters for the workpiece, the plurality of design dimensions for the workpiece, and the plurality of material parameters for the workpiece.

18. The system of claim 17, wherein the plurality of bend operation parameters comprises a first bend span, a first lateral bend offset, and a first longitudinal bend offset when the plurality of initial dimensional parameters includes a trueness deviation from the plurality of design dimensions for the workpiece.

19. The system of claim 17, wherein the plurality of bend operation parameters comprises a second bend span, a second lateral bend offset, and a second longitudinal bend offset when the plurality of initial dimensional parameters includes a flatness deviation from the plurality of design dimensions for the workpiece.

20. The system of claim 17, wherein the plurality of bend operation parameters comprises a twist level when the plurality of initial dimensional parameters includes a twist deviation from the plurality of design dimensions for the workpiece.
